(19) United States
(12) Patent Application Publication
(10) Pub. No.: US 2009/0164359 A1
(43) Pub. Date: Jun. 25, 2009

(54) SINGLE ACTION BIDDING

(75) Inventors: Jeffrey Loui, San Francisco, CA (US); Hemal Doshi, San Jose, CA (US); Ramesh R. Mandapati, Santa Clara, CA (US); Subha Shetty, Santa Clara, CA (US); Kenneth Allen Pate, San Jose, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc., San Jose, CA (US)

(21) Appl. No.: 11/962,790

(22) Filed: Dec. 21, 2007

(51) Int. Cl. G06Q 30/00

(52) U.S. Cl. 705/37

(57) ABSTRACT

Apparatus, systems, and methods may operate to present an item for bidding as part of an electronic auction conducted by a networked computer system, and to present a request for a single action bid by a bidder to simultaneously enter and confirm a single action bid amount for the item. Additional apparatus, system, and methods are disclosed.

### BACKGROUND

The ubiquitous presence of computers and the increasing use of electronic communication has fueled the growth of computer networks. Many individual computer users take advantage of this environment to participate in online markets, including as bidders in electronic auctions. The proliferation of bidders in these auctions makes for a transactional environment that is both robust, and increasingly competitive.

### BRIEF DESCRIPTION OF THE DRAWINGS

The present disclosure is illustrated by way of example and not limitation in the figures of the accompanying drawings, in which:

FIG. 1 is a simplified diagram of a graphical user interface to implement single action bidding according to various embodiments of the invention.

FIG. 2 is a simplified diagram of an alternative graphical user interface to implement single action bidding according to various embodiments of the invention.

FIG. 3 is a block diagram of apparatus and systems according to various embodiments of the invention.

FIG. 4 is a flow diagram illustrating methods according to various embodiments of the invention.

FIG. 5 is a block diagram illustrating applications that can be used to implement single action bidding according to various embodiments of the invention.

FIG. 6 is a block diagram illustrating a client-server architecture to facilitate single action bidding according to various embodiments of the invention.

FIG. 7 is a block diagram of a machine in the example form of a computer system according to various embodiments of the invention.

### DETAILED DESCRIPTION

### Introduction

In the online auction marketplace, items are typically offered for sale over some time period. Sometimes immediate purchases are made, closing the auction prematurely. However, in most cases, bidders compete against each other and offer bids on desirable items until the auction closes. The process of bidding typically involves three steps: entering a bid amount, submitting the bid amount, and confirming entry of the bid. Once these steps are accomplished, the bid is accepted as valid and entered into the auction.

Some bidders have perfected the art of waiting until the last few seconds before an auction closes before confirming their bid. Various strategies are employed, including opening multiple bidding windows, constantly refreshing yet another window to view the current auction price, and attempting to confirm one of multiple entered bids at the right time. However, such bidders are often frustrated by failing to confirm their bid in time, or being beaten by others that use the same strategy in the same auction.

In some embodiments, the inventors have discovered that the problem of confirming bids of the proper amount more quickly, as well as other problems presented in increasingly competitive bidding environments, can be solved by creating a single action bidding system, called a “one click bid” in some embodiments. When this mechanism is used, the most recent bid price for a selected item is shown, along with a new bid amount. To enter the bid as shown, the bidder need only take a single action (e.g., click on the new bid amount using a mouse), and the bid will be accepted immediately as a valid one. In other words, the bid is entered and confirmed by a single action of the bidder.

In some embodiments of single action bidding, the minimum bid amount to be entered using a single action is shown directly (e.g., a one click minimum bid amount of $102.50 USD). In other embodiments, the bidder can type in the single action bid amount, and then enter and confirm the indicated amount as a bid with a single action (e.g., a one click bid).

### Example Operations

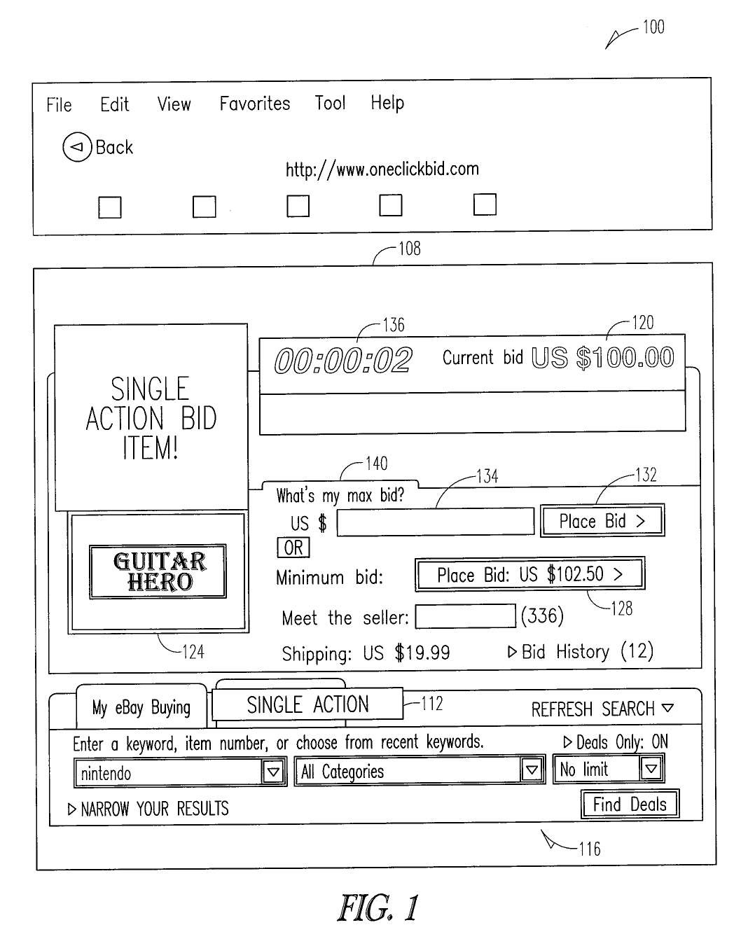

FIG. 1 is a simplified diagram of a graphical user interface (GUI) 100 to implement single action bidding according to various embodiments of the invention. The interface 100 is one of many that are possible. In the particular example of FIG. 1, a sample web page 108 that might be seen by an individual bidder logged into a terminal that enables single action bidding for items and groups of items, is shown. It should be understood that items may comprise goods, services, and combinations of these.

Here, a current bid amount 120 of $100 USD is shown for the displayed item 124 that is being offered for sale. Two opportunities to place a single action bid exist. The first permits the bidder to type or otherwise indicate a bid amount into the bidding window 134, so that the bid amount so indicated can be both entered and confirmed using the single action of clicking a mouse on the “Place Bid” widget 132. The second permits the bidder to both enter and confirm a machine-determined bid amount (e.g., $102.50 USD), shown as part of the “Place Bid” widget 128, by clicking on the widget 128. In each case, a bid is both entered and confirmed using a single action by the bidder.

Until the time left for bidding 136 has ended, the bidder may continue to enter increasing minimum bid amounts by simply clicking once on the widget 128, with the knowledge that each new amount will be greater than the most-recently indicated current bid amount 120. Alternatively, the bidder may continue to select, enter, and confirm an indicated bid amount using the window 134 and the widget 132, perhaps bypassing entries by other bidders that may be using the minimum bid widget 128 to enter their bids. The amount entered and confirmed using a single action via either mechanism may be limited automatically by the system, or explicitly by the bidder, using a previously-selected maximum bid amount 140. Items that are currently offered under the single action bid mechanism may be located by choosing the single action tab 112, and narrowed using a desired keyword and/or category in the search windows 116.

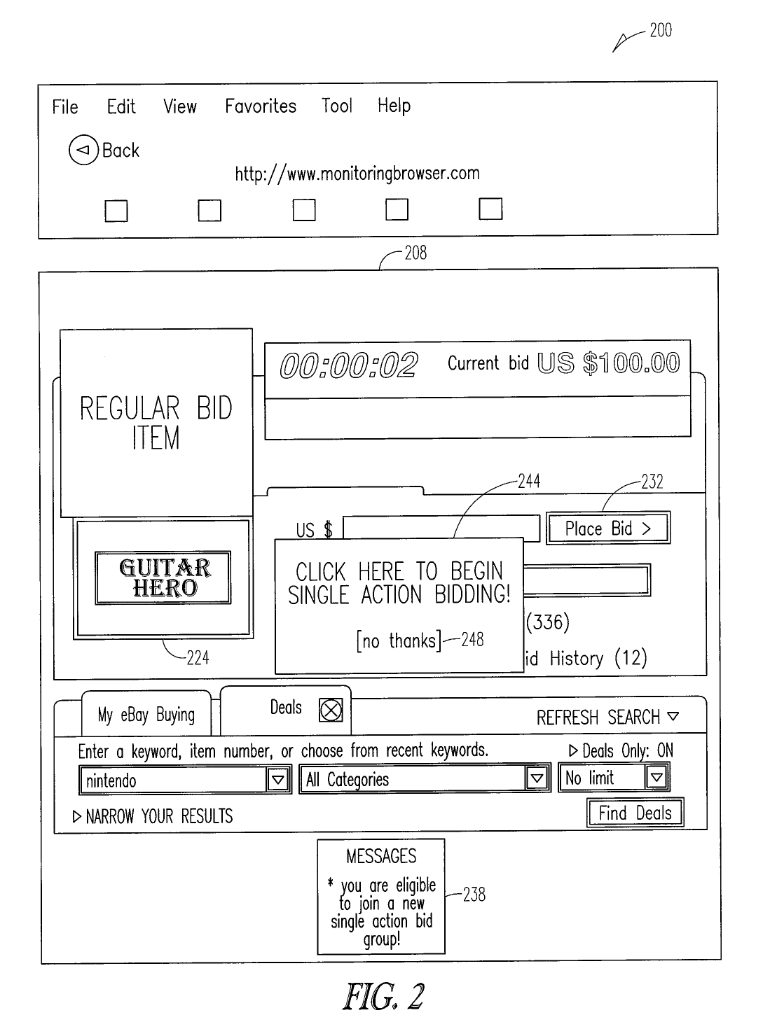

FIG. 2 is a simplified diagram of an alternative GUI 200 to implement single action bidding according to various embodiments of the invention. The GUI 200 shown is just one of many that are possible. In the particular example of FIG. 2, a sample of what might be seen by a bidder that is browsing regular bid items on a web page 208 forming a portion of an online marketplace is shown.

In this particular display, an item 224 is displayed and offered for sale as part of a regular bidding system where a bid widget 232 is used to enter a bid price that is subsequently confirmed using additional steps. However, prior to bidding in the normal fashion, the bidder might be shown a single action bidding offer window 244, with the option to click on the window in one location to initiate the single action bidding mode, or to click in another location of the window 244 to decline entry into the single action bidding mode. In some embodiments, the bidder may be informed, using a message window 238, of opportunities to join a group that will begin single action bidding at some future time, among other opportunities. Other information regarding single action bidding activity may be displayed in the window 238. Many other variations are possible, as noted above.

### Example Apparatus and Systems

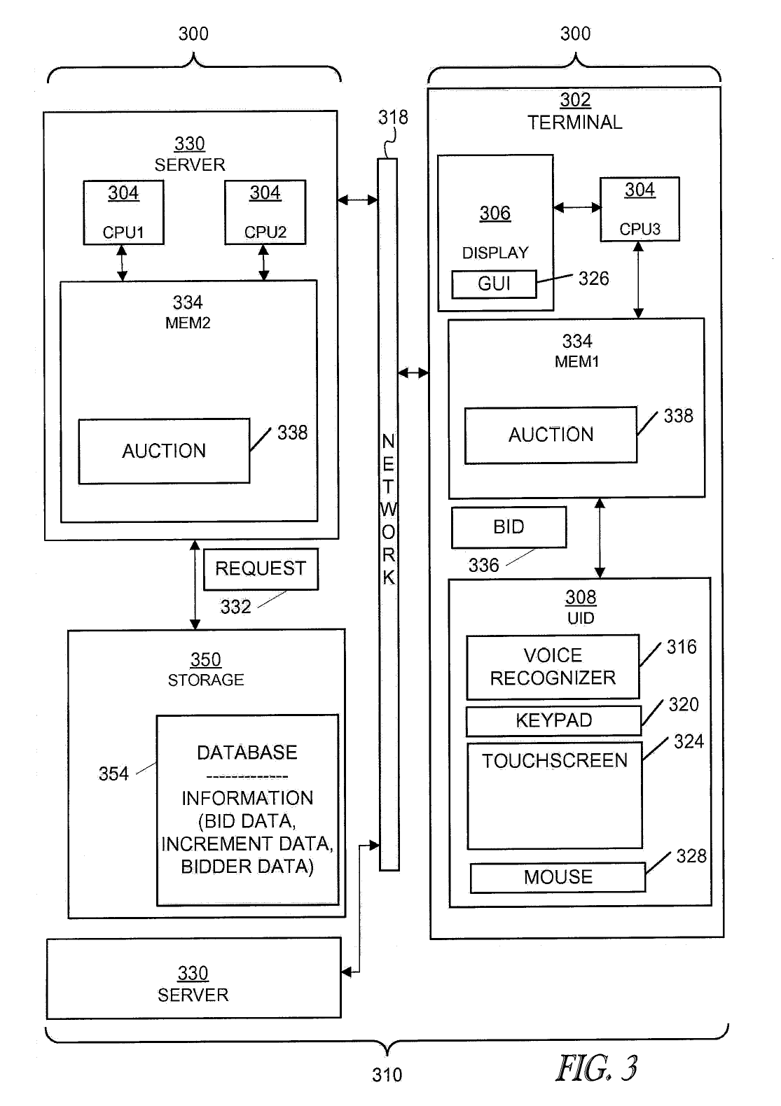

FIG. 3 is a block diagram of apparatus 300 and systems 310 according to various embodiments of the invention. The apparatus 300 may comprise many devices, such as a terminal 302, a server 330, a generic computer, and other devices with computational capability. The apparatus 300 may include one or more processors 304 coupled to a memory 334.

Single action bids 336, such as those made by a bidder with respect to various items forming part of an online marketplace, may be received by the apparatus 300 and stored in the memory 334, and/or processed by a combination of the processor 304 and the auction module 336. The single action bids 336 may be initiated unilaterally, or in response to a request 332 originating from the server 330 (e.g., as part of a programmatic invitation), or the terminal 302 (e.g., as part of a bidder's request to enter into an auction with the ability to generate single action bids 336).

One or more of the processors 304 and the auction module 338 may be included in a single server 330. The apparatus 300 may include one or more storage devices 350 to store a data structure 354 (e.g., a database) that includes a variety of information, including bid data (e.g., prior bids, new bids, whether an item qualifies for single action bidding, etc.), bid increment data (e.g., amount of the bid increment, source of the bid increment specification, basis of the bid increment, etc.), and bidder data (e.g., bidder identity, bidder history, etc.), among others.

The apparatus 300 may include one or more user input devices 308, perhaps used to generate bids 336. The user input devices 308 may comprise one or more of a voice recognizer 316, a keyboard or keypad 320, a touch screen 324, or a mouse 328. The display 306 and/or the touch screen 324 may be used to display one or more GUIs 326, such as those shown in FIGS. 1 and 2. The GUI 326 may be used to present opportunities for participating in single action bid auctions, as well as entry of the single action bids themselves.

A system 310 to enable and process single action bidding may include one or more of the apparatus 300, such as one or more terminals 302, and one or more servers 330. The terminals 302 may take the form of a desktop computer, a laptop computer, a cellular telephone, a point of sale (POS) terminal, and other devices that can be coupled to the servers 330 via a network 318. Terminals 302 may include one or more processors 304, and memory 334. The network 318 may comprise a wired network, a wireless network, a local area network (LAN), or a network of larger scope, such as a global computer network (e.g., the Internet). Thus, the terminal 302 may comprise a wireless terminal. Each of the servers 330 and terminals 302 may be used as a source of requests 332 for single action bids, as well as the single action bids 336 themselves, perhaps as shown in FIGS. 1 and 2.

Therefore, many embodiments may be realized. For example, a system 310 may comprise a network of servers 330 including a computer to communicatively couple to a computer network 318. The system 310 may further comprise an auction module 338 to present one or more items for bidding as part of an electronic auction conducted by the computer, and one or more requests 332 for a single action bid 336 by a bidder to simultaneously enter and confirm a single action bid amount for the item(s).

The system 310 may include one or more user terminals 302 to couple to the computer (e.g., server 330) and to present a GUI 326 to receive one or more single action bids 336. A storage device 350 to couple to the computer may be used to store a database 354 having information associated with the bidder and bidding activity associated with the single action bid 336.

### Example Methods

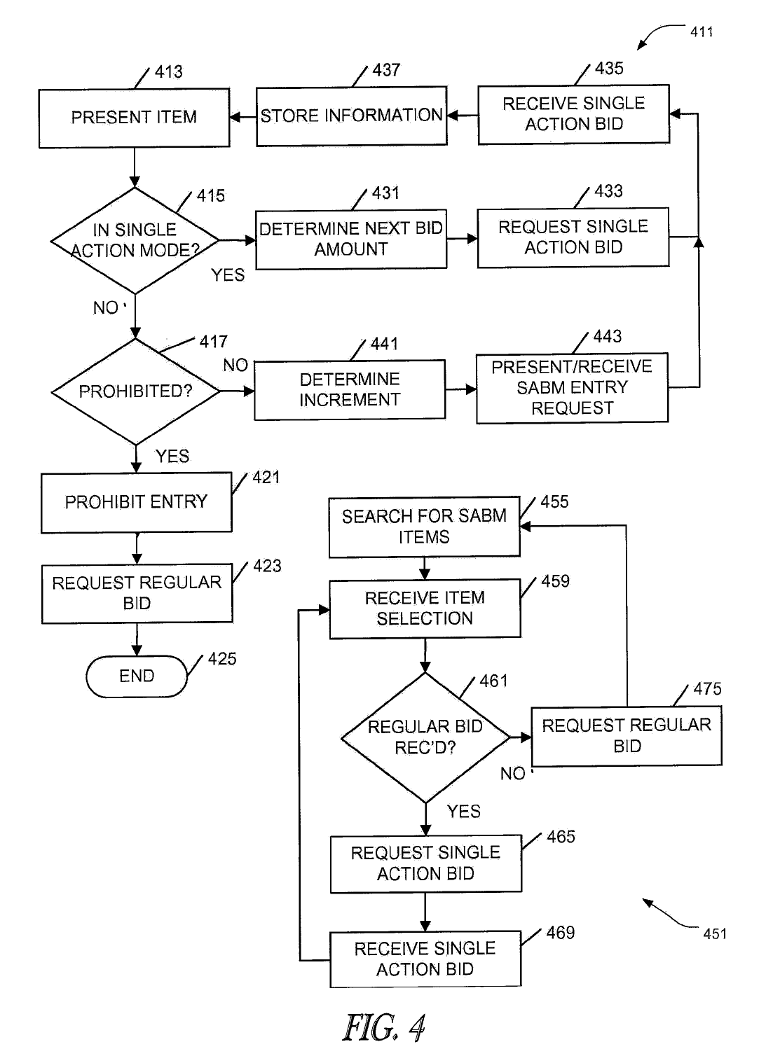

FIG. 4 is a flow diagram illustrating methods 411, 451 according to various embodiments of the invention. For example, a computer-implemented method 411 to implement single action bidding may begin at block 413 with presenting one or more items for bidding as part of an electronic auction conducted by a networked computer system.

If the electronic auction is already being conducted with single action bid entry mode enabled, as indicated at block 415, then the method 411 may continue on to block 431 with determining the next amount to be bid using single action bidding. The bid increment may be bidder-specified, so that when a new bid is received, a bidder-specified increment may be added to it, and one or more bidders may then be asked to act on entering the updated bid amount. Thus, responsive to receiving a current bid amount greater than the prior single action bid amount, the method 411 may include presenting a single action bid increment amount (e.g., specified by the bidder) added to the current bid amount as part of a subsequent single action bid request.

Many additional possibilities exist for determining what amount should be entered for the next single action bid. For example, the single action bid increment amount might be determined automatically, perhaps based on any one or more of a designated minimum increment amount (e.g., each single action bid might be incremented by $1 USD), a designated absolute increment amount (e.g., each single action bid might be incremented by a selected one of either $5 USD, $10 USD, or $15 USD), an amount relative to a current bid amount (e.g., each single action bid might be incremented by 5% or 10% of the current bid amount), a stored personal limit amount (e.g., each bidder might enter their own personal limit on bid increments, such as an increment of $5, above which the current bid is not to be incremented prior to entry by that bidder), an amount relative to a sales price for previously-closed items (e.g., each single action bid might be incremented by 5% of a closing price for the most recent similar or identical item sold, or an average of such items having auctions ending during the previous week), an amount relative to a retail list value (e.g., some percentage of the manufacturers suggest retail price), or an amount relative to price in another market (e.g., each single action bid might be incremented by a percentage of the price similar to or identical to items are valued in a collector's catalogue, or a vehicle dealer's sales price handbook). In each case, responsive to receiving a current bid amount greater than the prior single action bid amount, the method 411 may include presenting a single action bid increment amount added to the current bid amount as part of a subsequent single action bid request to one or more bidders.

The method 411 may thus continue on to block 433 with presenting a request for a single action bid by a bidder to simultaneously enter and confirm a single action bid amount for the item(s). The request for bid may be presented in many ways. This includes the presentation of the single action bid request at the same time as a request for regular bidding is presented.

In some embodiments, the method 411 may include presenting, as part of a single data entry window, the option of a bidder-specified bid amount or the request for a pre-determined single action bid (e.g., see FIG. 1). That is, the bidder may have the option of typing in an indicated bid amount, and then entering/confirming it with a single action, or simply be asked to click on a preselected bid amount to enter/confirm the amount.

In some embodiments, the method 411 may include presenting the item(s) and the request for a single action bid in a single window. The method 411 may also include presenting the item(s) and the request for a single action bid in separate windows.

The method 411 may continue on to block 435 with receiving the single action bid initiated by a single action of the bidder. The single action of the bidder might comprise a gesture, a sound, a mouse click, or a key press, for example. A gesture may comprise waving one or more hands, or some other body movement, including head nodding; sounds may comprise verbal commands. Receiving the single action bid at block 435 may comprise setting a time interval during which no more than a selected number of single action bids will be recognized from the bidder. For example, the number of single action bids recognized during a five second interval might be limited to two bids - any time interval or number of bids can be used in this fashion to limit the potential for entry of numerous machine-generated single action bids. Thus, in some embodiments, the method 411 may include, as part of receiving the bids at block 435, examining bidding activity associated with the bidder, and halting the bidding activity responsive to determining that a number of single action bids entered during a selected time interval exceeds a preselected number of single action bids. In this manner, improbably large numbers of single action bids emanating from a single source can be prevented.

The method 411 may continue on to block 437 with storing information associated with the bidder and bidding activity (including the single action bid amount, if desired). Thus, single action bidding activity can be stored for later access to drive other activities, such as advertising and other promotions.

If single action bidding has not yet been enabled, as determined at block 415, and single action bidding for the presented item is not prohibited, as determined at block 417, then the method 411 may continue at block 441 with determining the increment to use for single action bidding. Increment determination may proceed as noted for block 431 above, including by explicitly requesting a single action bid increment amount (e.g., a system may present a request to the bidder to enter the desired single action bid increment).

The method 411 may continue on to block 443 with presenting or receiving a request to enter into the single action bidding mode (SABM). This can occur in a number of ways.

For example, the method 411 may include presenting a direct request to the bidder to enter into a single action bid entry mode. The method 411 may also include receiving a request initiated by the bidder and associated with the item(s) presented to enter into a single action bid entry mode.

In some embodiments, the method 411 may include presenting an opportunity to enter into a single action bid entry mode when a preselected amount of time has elapsed since the electronic auction started. That is, bidders can be prompted to enter into the SABM some time after bidding starts. They can also be prompted to enter the SABM some time before bidding ends. Thus, the method 411 may include offering an opportunity to enter into a single action bid entry mode at a preselected amount of time before the electronic auction ends.

In some embodiments, the method 411 may include presenting an opportunity to enter into a single action bid entry mode for a selected group of bidders at any time. In this way, bidders can selectively be invited into the single action bid mode based on a variety of factors, such as a seller/buyer rating, a tag associated with the item up for bid, a hyperlink associated with the item or the bidder, the presented item category, the presented item expected bidding price range, the brand of the item, a role associated with the bidder (e.g., company purchasing agent), a group associated with the bidder, a portion of a user profile associated with the bidder, the name of the bidder forming part of a database of experienced single action bidders, keywords in a comment entered by the bidder, or a lottery system (e.g., only five bidders out of all active bidders will be randomly selected to participate in single action bid entry.

In some embodiments, the method 411 may include searching information associated with the bidder, and presenting an opportunity to enter into a single action bid entry mode based on the information. For example, bidder information (e.g., profiles) can be searched, and used to invite likely bidders into single action bid auctions that fit selected profile elements.

If single action bidding is prohibited, as determined at block 417, then the method 411 may continue on to block 421 with prohibiting entry into a single action bid entry mode for items associated with one or more preselected characteristics. For example, single action bidding may be prevented for certain items, such as those falling into a certain category or price range, those that may be purchased by children, or those sold by a particular entity.

The method 411 may then continue on to block 423 with requesting a regular bid for the presented item (i.e., a non-single action bid). The method 411 may then conclude at block 425. Still other embodiments may be realized.

For example, some computer-implemented methods 451 of presenting items for single action bidding may begin at block 455 with searching for items that are eligible for single action bidding. That is, the method 451 may include presenting an option to search for auction items having a single action bid entry mode enabled or disabled (e.g., if the bidder desires to avoid such items). In this way, bidders can search for items that have single action bidding active, or exclude such items from their searching efforts.

Once one or more items are selected for single action bidding at block 459, the method 451 may include requiring receipt of a non-single action bid (i.e., regular bid) on the item(s) prior to permitting entry into single action bid entry mode. This mechanism can be used to prevent entry into the single action mode until after a regular bid has been placed. If no regular bid has been received as determined at block 461, the method 451 may include requesting a regular bid at block 475 (similar or identical to the activity described for block 423).

If a regular bid has been received, as determined at block 461, the method 411 may continue on to block 465 and 469 with requesting a single action bid, and receiving a single action bid, in a manner similar to or identical to those activities described with respect to blocks 433 and 435, respectively.

The methods 411, 451 described herein do not have to be executed in the order described, or in any particular order. Moreover, various activities described with respect to the methods identified herein can be executed in repetitive, serial, or parallel fashion. Information, including parameters, commands, operands, and other data, can be sent and received in the form of one or more carrier waves.

One of ordinary skill in the art will understand the manner in which a software program can be launched from a computer-readable medium in a computer-based system to execute the functions defined in the software program. Various programming languages may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using a number of mechanisms well known to those skilled in the art, such as application program interfaces or interprocess communication techniques, including remote procedure calls. The teachings of various embodiments are not limited to any particular programming language or environment.

Thus, the methods described herein may be performed by processing logic that comprises hardware (e.g., dedicated logic, programmable logic), firmware (e.g., microcode, etc.), software (e.g., algorithmic or relational programs run on a general purpose computer system or a dedicated machine), or any combination of the above. It should be noted that the processing logic may reside in any of the modules described herein.

Therefore, other embodiments may be realized, including a machine-readable medium (e.g., the memories 334 of FIG. 3) encoded with instructions for directing a machine to perform operations comprising any of the methods described herein. For example, some embodiments may include a machine-readable medium encoded with instructions for directing a server or client terminal or computer to perform a variety of operations. Such operations may include any of the activities presented in conjunction with the methods 411, 451 described above. Various embodiments may specifically include a machine-readable medium comprising instructions, which when executed by one or more processors, cause the one or more processors to perform any of the activities recited by such methods.

### Marketplace Applications

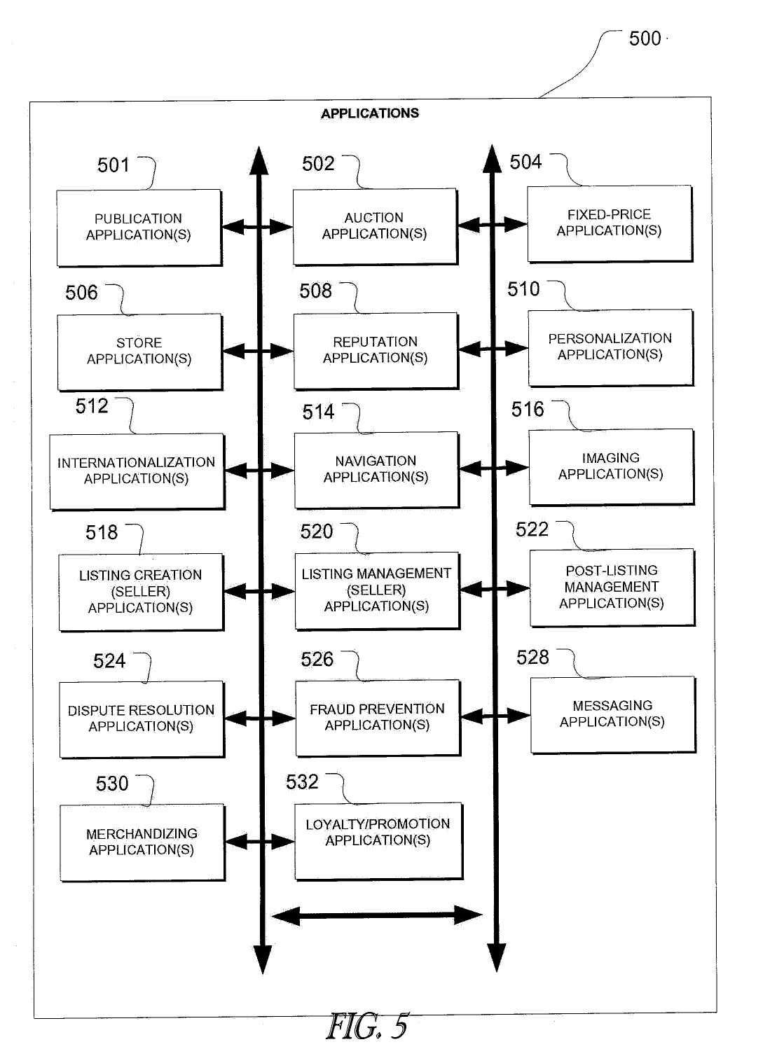

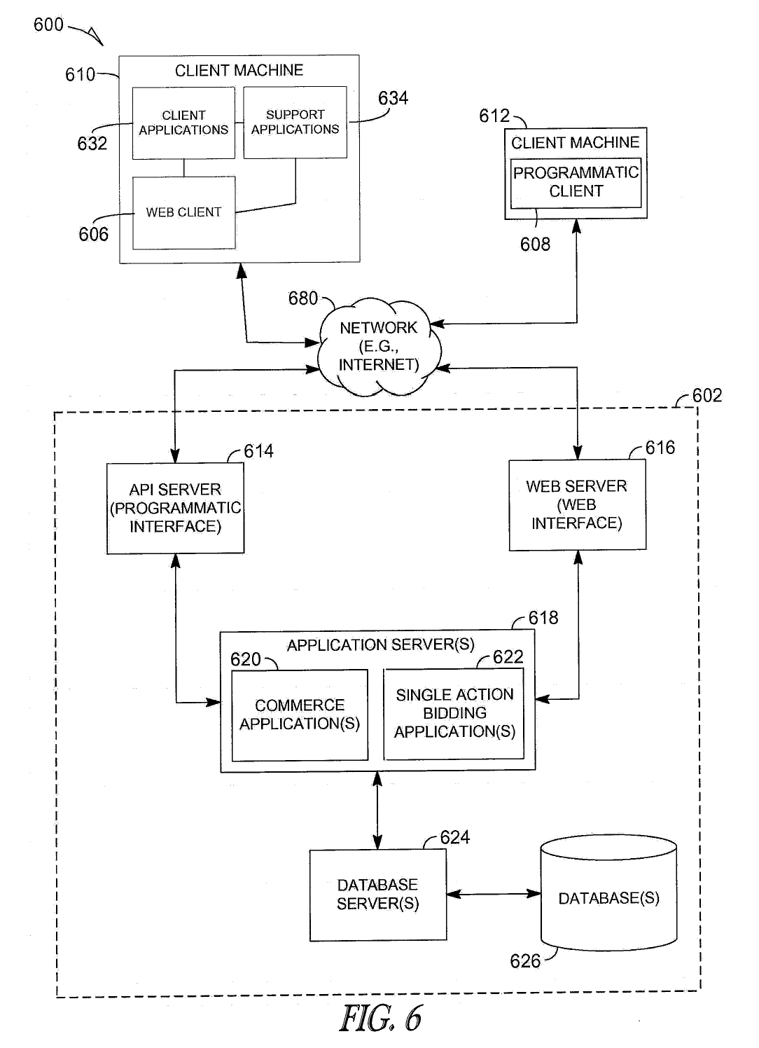

FIG. 5 is a block diagram illustrating applications 500 that can be used to implement single action bidding according to various embodiments of the invention. These applications 500 can be provided as part of a networked system, including the system 310 and architecture 600 of FIGS. 3 and 6, respectively. The applications 500 may be hosted on dedicated or shared server machines that are communicatively coupled to enable communications between server machines. Thus, for example, any one or more of the applications 500 may be stored in memories 334 of the system 310, and/or executed by the processors 304, as shown in FIG. 3.

The applications 500 themselves are communicatively coupled (e.g., via appropriate interfaces) to each other and to various data sources, so as to allow information to be passed between the applications 500, or so as to allow the applications 500 to share and access common data. The applications 500 may furthermore access one or more databases via database servers (e.g., database server 624 of FIG. 6). Any one or all of the applications 500 may serve as a source of requests, bids, and associated information for processing single action bidding activity according to the methods described herein. The applications 500 may also serve as a source of determined user preferences and/or expressed user preferences (e.g., bid increment amounts taken from a bidder profile, or explicitly entered by a bidder).

In some embodiments, the applications 500 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the applications 500 may include a number of marketplace applications, such as at least one publication application 501 and one or more auction applications 502 which support auction-format listing and price setting mechanisms (e.g., English, Dutch, Vickrey, Chinese, Double, Reverse auctions etc.). The various auction applications 502 may also provide a number of features in support of such auction-format listings, such as a reserve price feature whereby a seller may specify a reserve price in connection with a listing and a proxy-bidding feature whereby a bidder may invoke automated proxy bidding. The auction applications 502 may be coupled to or included within the auction modules 338 of FIG. 3.

A number of fixed-price applications 504 support fixed-price listing formats (e.g., the traditional classified advertisement-type listing or a catalogue listing) and buyout-type listings. Specifically, buyout-type immediate purchase listings (e.g., including the BIN technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 506 allow a seller to group listings within a “virtual” store, which may be branded and otherwise personalized by and for the seller. Such a virtual store may also offer promotions, incentives and features that are specific and personalized to a relevant seller.

Reputation applications 508 allow users that transact business, perhaps utilizing a networked system, to establish, build and maintain reputations, which may be made available and published to potential trading partners. When, for example, a networked system supports person-to-person trading, users may otherwise have no history or other reference information whereby the trustworthiness and credibility of potential trading partners may be assessed. The reputation applications 508 allow a user, through feedback provided by other transaction partners, to establish a reputation within a networked system over time. Other potential trading partners may then reference such reputations for the purposes of assessing credibility and trustworthiness.

Personalization applications 510 allow users of networked systems to personalize various aspects of their interactions with the networked system. For example a user may, utilizing an appropriate personalization application 510, create a personalized reference page at which information regarding transactions to which the user is (or has been) a party may be viewed. Further, a personalization application 510 may enable a user to personalize listings and other aspects of their interactions with the networked system and other parties.

Marketplaces may be customized for specific geographic regions. Thus, one version of the applications 500 may be customized for the United Kingdom, whereas another version of the applications 500 may be customized for the United States. Each of these versions may operate as an independent marketplace, or may be customized (or internationalized) presentations of a common underlying marketplace. The applications 500 may accordingly include a number of internationalization applications 512 that customize information (and/or the presentation of information) by a networked system according to predetermined criteria (e.g., geographic, demographic or marketplace criteria). For example, the internationalization applications 512 may be used to support the customization of information for a number of regional websites that are operated by a networked system and that are accessible via respective web servers.

Navigation of a networked system may be facilitated by one or more navigation applications 514. For example, a search application (as an example of a navigation application) may enable key word searches of listings published via a networked system publication application 501. A browse application may allow users to browse various category, catalogue, or inventory data structures according to which listings may be classified within a networked system. Various other navigation applications may be provided to supplement the search and browsing applications.

In order to make listings available on a networked system as visually informing and attractive as possible, marketplace applications may operate to include one or more imaging applications 516 which users may use to upload images for inclusion within listings. An imaging application 516 can also operate to incorporate images within viewed listings. The imaging applications 516 may also support one or more promotional features, such as image galleries that are presented to potential buyers. For example, sellers may pay an additional fee to have an image included within a gallery of images for promoted items.

Listing creation applications 518 allow sellers conveniently to author listings pertaining to goods or services that they wish to transact via a networked system, and listing management applications 520 allow sellers to manage such listings. Specifically, where a particular seller has authored and/or published a large number of listings, the management of such listings may present a challenge. The listing management applications 520 provide a number of features (e.g., auto-relisting, inventory level monitors, etc.) to assist the seller in managing such listings. One or more post-listing management applications 522 can assist sellers with activities that typically occur post-listing. For example, upon completion of an auction facilitated by one or more auction applications 502, a seller may wish to leave feedback regarding a particular buyer. To this end, a post-listing management application 522 may provide an interface to one or more reputation applications 508, so as to allow the seller conveniently to provide feedback regarding multiple buyers to the reputation applications 508.

Dispute resolution applications 524 provide mechanisms whereby disputes arising between transacting parties may be resolved. For example, the dispute resolution applications 524 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 526 implement fraud detection and prevention mechanisms to reduce the occurrence of fraud within a networked system.

Messaging applications 528 are responsible for the generation and delivery of messages to users of a networked system, such messages for example advising users regarding the status of listings on the networked system (e.g., providing “outbid” notices to bidders during an auction process or to provide promotional and merchandising information to users). Respective messaging applications 528 may utilize any number of message delivery networks and platforms to deliver messages to users. For example, messaging applications 528 may deliver electronic mail (e-mail), instant message (IM), Short Message Service (SMS), text, facsimile, or voice (e.g., Voice over IP (VoIP)) messages via wired (e.g., Ethernet, Plain Old Telephone Service (POTS)), or wireless (e.g., mobile, cellular, WiFi, WiMAX) networks.

Merchandising applications 530 support various merchandising functions that are made available to sellers to enable sellers to increase sales via a networked system. The merchandising applications 530 also operate the various merchandising features that may be invoked by sellers, and may monitor and track the success of merchandising strategies employed by sellers.

A networked system itself, or one or more users that transact business via the networked system, may operate loyalty programs that are supported by one or more loyalty/promotions applications 532. For example, a buyer may earn loyalty or promotions points for each transaction established and/or concluded with a particular seller, and be offered a reward for which accumulated loyalty points can be redeemed.

FIG. 6 is a block diagram illustrating a client-server architecture 600 to facilitate single action bidding according to various embodiments of the invention. A platform, such as a network-based information management system 602, provides server-side functionality via a network 680 (e.g., the Internet) to one or more clients. FIG. 6 illustrates, for example, a web client 606 (e.g., a browser, such as the Internet Explorer browser developed by Microsoft Corporation of Redmond, Wash.), and a programmatic client 608 executing on respective client machines 610 and 612. In some embodiments, either or both of the web client 606 and programmatic client 608 may include a mobile device.

Turning specifically to the system 602, an Application Program Interface (API) server 614 and a web server 616 are coupled to, and provide programmatic and web interfaces respectively to, one or more application servers 618. The application servers 618 host one or more commerce applications 620 (e.g., similar to or identical to the applications 500 of FIG. 5) and single action bidding applications 622 (e.g., perhaps included within the modules 338 of FIG. 3). The application servers 618 are, in turn, shown to be coupled to one or more database servers 624 that facilitate access to one or more databases 626 (similar to or identical to the structure 354 of FIG. 3), such as registries that include links between individuals, their profiles, their behavior patterns, user-generated information, requests, bids, and bid increments.

Further, while the system shown in FIG. 6 employs a client-server architecture 600, the various embodiments are of course not limited to such an architecture, and could equally well be applied in a distributed, or peer-to-peer, architecture system. The various applications 620 and 622 may also be implemented as standalone software programs, which do not necessarily have networking capabilities.

The web client 606, it will be appreciated, may access the various applications 620 and 622 via the web interface supported by the web server 616. Similarly, the programmatic client 608 accesses the various services and functions provided by the applications 620 and 622 via the programmatic interface provided by the application programming interface (API) server 614. The programmatic client 608 may, for example, comprise a browser module to enable a user to submit selections of items, or queries, perhaps performing batch-mode communications between the programmatic client 608 and the network-based system 602. Client applications 632 and support applications 634 may perform similar or identical functions.

### Example Machine Architecture

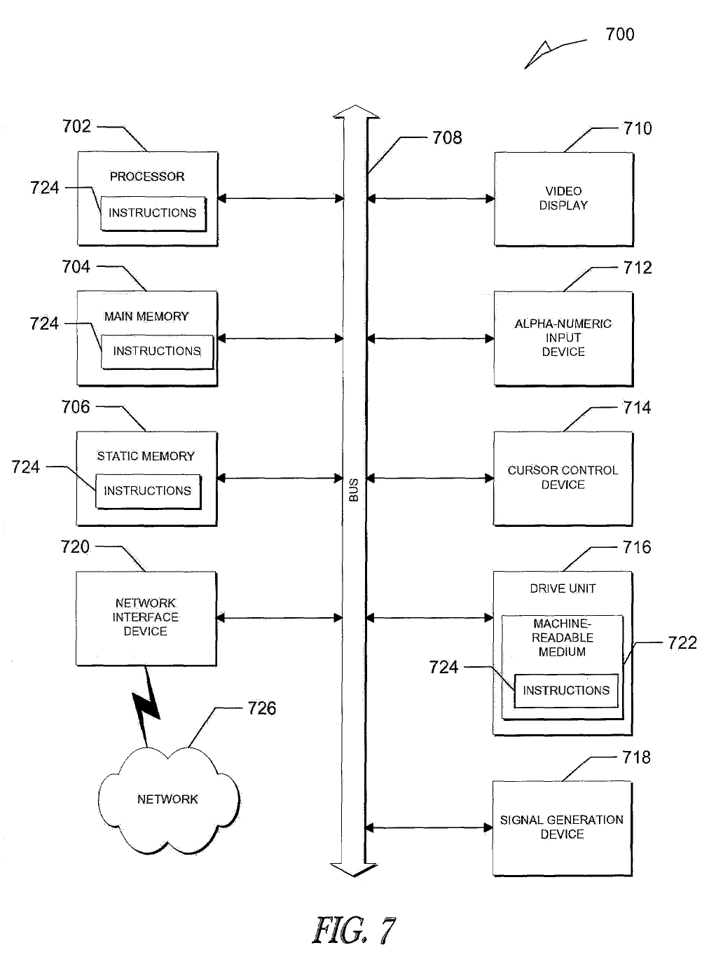

FIG. 7 is a block diagram of a machine 700 in the example form of a computer system according to various embodiments of the invention. The computer system shown may include a set of instructions for causing the machine to perform any one or more of the methodologies discussed herein. The machine 700 may also be similar to or identical to the terminal 302 or server 330 of FIG. 3.

In some embodiments, the machine 700 may operate as a standalone device or may be connected (e.g., networked) to other machines. In a networked deployment, the machine 700 may operate in the capacity of a server or a client machine in a server-client network environment, or as a peer machine in a peer-to-peer (or distributed) network environment.

The machine 700 may comprise a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example machine 700 may include a processor 702 (e.g., a central processing unit (CPU), a graphics processing unit (GPU) or both), a main memory 704 and a static memory 706, all of which communicate with each other via a bus 708. The machine 700 may further include a video display unit 710 (e.g., liquid crystal displays (LCD) or cathode ray tube (CRT)). The display unit 710 may be used to display a GUI according to the embodiments described with respect to FIGS. 1 and 2. The machine 700 also may include an alphanumeric input device 712 (e.g., a keyboard), a cursor control device 714 (e.g., a mouse), a disk drive unit 716, a signal generation device 718 (e.g., a speaker), and a network interface device 720.

The disk drive unit 716 may include a machine-readable medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media. The software 724 may further be transmitted or received over a network 726 via the network interface device 720, which may comprise a wired and/or wireless interface device.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include tangible media that include, but are not limited to, solid-state memories, optical, and magnetic media.

Certain applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information).

In conclusion, it can be seen that various embodiments of the invention can operate to present a unique bidding experience to a bidder participating in an auction forming a portion of an online marketplace. The embodiments disclosed can present items in conjunction with purchasing opportunities where bids can be entered and confirmed with a single action on the part of the bidder. This type of interface can be offered as an alternative to that available when more conventional auction mechanisms are used. Increased user satisfaction may result.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method, comprising:
presenting at least one item for bidding as part of an electronic auction conducted by a networked computer system; and
presenting a request for a single action bid by a bidder to simultaneously enter and confirm a single action bid amount for the at least one item.

2. The computer-implemented method of claim 1, comprising:
presenting a request to the bidder to enter into a single action bid entry mode.

3. The computer-implemented method of claim 1, comprising:
receiving a request initiated by the bidder and associated with the at least one item to enter into a single action bid entry mode.

4. The computer-implemented method of claim 1, comprising:
receiving the single action bid initiated by a single action of the bidder, wherein the single action comprises one of a gesture, a sound, a mouse click, or a key press.

5. The computer-implemented method of claim 1, comprising:
prohibiting entry into a single action bid entry mode for items associated with one or more preselected characteristics.

6. The computer-implemented method of claim 1, comprising:
requesting a single action bid increment amount.

7. The computer-implemented method of claim 6, comprising:
responsive to receiving a current bid amount greater than the single action bid amount, presenting the single action bid increment amount added to the current bid amount as part of a subsequent single action bid request.

8. The computer-implemented method of claim 1, comprising:
determining a single action bid increment amount based on one of a minimum increment amount, a designated absolute increment amount, an amount relative to a current bid amount, a stored personal limit amount, an amount relative to a sales price for previously-closed items, an amount relative to a retail list value, or an amount relative to price in another market.

9. The computer-implemented method of claim 8, comprising:
responsive to receiving a current bid amount greater than the single action bid amount, presenting the single action bid increment amount added to the current bid amount as part of a subsequent single action bid request.

10. The computer-implemented method of claim 1, comprising:
presenting, as part of a single data entry window, an option of a bidder-specified bid amount or the request for the single action bid.

11. The computer-implemented method of claim 1, wherein presenting the request comprises:
presenting the at least one item and the request for the single action bid in a single window.

12. The computer-implemented method of claim 1, wherein presenting the request comprises:
presenting the at least one item and the request for the single action bid in separate windows.

13. The computer-implemented method of claim 1, comprising:
presenting an opportunity to enter into a single action bid entry mode when a preselected amount of time has elapsed since the electronic auction started.

14. The computer-implemented method of claim 1, comprising:
offering an opportunity to enter into a single action bid entry mode at a preselected amount of time before the electronic auction ends.

15. The computer-implemented method of claim 1, comprising:
presenting an option to search for auction items having a single action bid entry mode enabled or disabled.

16. The computer-implemented method of claim 1, comprising:
requiring receipt of a non-single action bid on the at least one item prior to permitting entry into a single action bid entry mode.

17. The computer-implemented method of claim 1, comprising:
presenting an opportunity to enter into a single action bid entry mode for a selected group of bidders, including the bidder.

18. The computer-implemented method of claim 1, comprising:
setting a time interval during which no more than a selected number of single action bids will be recognized from the bidder.

19. A system, comprising:
a computer to communicatively couple to a computer network; and
an auction module to present at least one item for bidding as part of an electronic auction conducted by the computer, and to present a request for a single action bid by a bidder to simultaneously enter and confirm a single action bid amount for the at least one item.

20. The system of claim 19, comprising:
a user terminal to couple to the computer and to present a graphical user interface to receive the single action bid.

21. The system of claim 19, comprising:
a storage device to couple to the computer and to store a database having information associated with the bidder and bidding activity associated with the single action bid.

22. A machine-readable medium comprising instructions, which when executed by one or more processors, cause the one or more processors to perform the following operations:
present at least one item for bidding as part of an electronic auction conducted by a networked computer system; and
present a request for a single action bid by a bidder to simultaneously enter and confirm a single action bid amount for the at least one item.

23. The machine-readable medium of claim 22, wherein the instructions, when executed by the one or more processors, cause the one or more processors to perform the following operations:
store information associated with the bidder and bidding activity including the single action bid amount.

24. The machine-readable medium of claim 22, wherein the instructions, when executed by the one or more processors, cause the one or more processors to perform the following operations:
examine bidding activity associated with the bidder; and
halt the bidding activity responsive to determining that a number of single action bids entered during a selected time interval exceeds a preselected number of single action bids.

25. The machine-readable medium of claim 24, wherein the instructions, when executed by the one or more processors, cause the one or more processors to perform the following operations:
search information associated with the bidder; and
present an opportunity to enter into a single action bid entry mode based on the information.
